(19) United States
(12) Patent Application Publication
(10) Pub. No.: US 2014/0170313 A1
(43) Pub. Date: Jun. 19, 2014

(54) HIGH-PERFORMANCE FIBROUS PRODUCTS

(71) Applicant: NANOPAPER, LLC, Cambridge, MA (US)

(72) Inventors: Gangadhar Jogikalmath, Cambridge, MA (US); David S. Soane, Chestnut Hill, MA (US)

(73) Assignee: NANOPAPER, LLC, Cambridge, MA (US)

(21) Appl. No.: 14/018,903

(22) Filed: Sep. 5, 2013

Related U.S. Application Data
(63) Continuation of application No. PCT/US12/28054, filed on Mar. 7, 2012.

(51) Int. Cl. C09D 147/00; D21H 21/34; D21H 19/16

(52) U.S. Cl. CPC C09D 147/00; D21H 19/16; D21H 21/34
USPC 427/244; 524/555

(57) ABSTRACT

The invention relates to formulations and methods for coating a fibrous web, comprising an emulsion capable of deposition on the fibrous web, the emulsion comprising an aqueous continuous phase and a discontinuous internal phase comprising a surface-modifying agent. The fibrous web may comprise a population of fibers that are pretreated with a pretreatment polymer, such as a polycationic polymer. The fibrous web may contain cellulose fibers, or two populations of dissimilar fibers. The surface-modifying agent may contain a polymeric system that forms a coating polymer on fibers of the fibrous web following evaporation of the aqueous continuous phase of the emulsion.

### RELATED APPLICATIONS

This application is a continuation of International Application No. PCT/US12/28054, which designated the United States and was filed on Mar. 7, 2012, published in English, which claims the benefit of U.S. Provisional Application No. 61/450,407 filed Mar. 8, 2011. The entire teachings of the above applications are incorporated herein by reference.

### FIELD OF APPLICATION

This application relates generally to high-performance fibrous products.

### BACKGROUND

Filtration applications require that the media being used have durability and dimensional stability under the operating conditions for the product. For high performance applications, the filtration media can encounter extreme conditions, such as high temperatures, contact with oil or other solvents, or exposure to oil or water under high pressure. Most filtration media used for demanding applications such as intake filters, in-line fluid filters, engine oil filters and the like, are nonwoven products made using cellulose in combination with synthetic fibers. Such composites make use of the inexpensive cellulose fibers with strong synthetic fibers to impart desired functionalities. Desired functionalities include properties like wet or dry strength of the nonwoven product, durability, dimensional uniformity and stability, and consistently engineered thickness, fiber, and pore size. Such functionalities are desirable in other high-performance fibrous products as well.

Nonwoven composites comprising natural and synthetic fibers can be formed cost-effectively by traditional papermaking processes. When traditional papermaking is used to form natural-synthetic composites, though, performance limitations can be introduced. Synthetic fibers that are added to cellulosic fibers during traditional papermaking can bunch up in the headbox, interfering with the intimate mixing and fiber-fiber attachment needed to produce a durable web. In addition, the different surface energies of the two fiber populations (i.e., natural and synthetic) can prevent them from attaching to each other. Therefore, the typical combination of natural and synthetic fibers in a fibrous composite can perform poorly in filtration.

To enhance the strength and solvent resistance of the high-performance nonwoven product, as may be used for filter applications, these media can be impregnated with synthetic polymer solutions capable of curing during the wet-web drying to provide additional strength and solvent resistance. Thermosetting high temperature polymers such as phenol-formaldehyde resins are one such example of impregnating resins currently being used. Many polymeric resin systems used in impregnation are not water soluble and hence require organic solvents to enable them to coat the fibers. These impregnation processes also poorly control the thickness of polymeric coating deposited on the fibers, leading to variability and imprecision in pore sizing. Moreover, the solvent systems used for depositing the polymeric resins are typically flammable, hazardous to health, costly, and require specialized disposal.

A need exists in the art, therefore, for high-performance products made from fibrous webs using traditional papermaking techniques, where the product is strong and resistant to heat and oils. Such a product can be useful, for example, in filtration media. A need also exists for a coating process adaptable to nonwoven fibrous products that imparts desirable properties to the product, such as fire resistance, consistent pore size and stable dimensionality. Such a coating process desirably would comprise an aqueous system, so that the detrimental features of the solvent-based system would be avoided.

### SUMMARY

Disclosed herein, in embodiments, are formulations for coating a fibrous web, comprising an emulsion capable of deposition on the fibrous web, the emulsion comprising an aqueous continuous phase and a discontinuous internal phase comprising a surface-modifying agent. In embodiments, the fibrous web comprises a population of fibers that are pretreated with a pretreatment polymer. The pretreatment polymer can be a polycation. In embodiments, the fibrous web comprises cellulose fibers. In embodiments, the fibrous web comprises two populations of dissimilar fibers. In embodiments, the surface-modifying agent comprises a polymeric system that forms a coating polymer on fibers of the fibrous web following evaporation of the aqueous continuous phase of the emulsion. The surface-modifying agent can further comprise an additive. The additive can impart properties to the fibrous web such as fire resistance, flame retardation, lubricity, hydrophobicity, and plasticity. In embodiments, the polymeric system comprises a polymeric precursor. In embodiments, the surface-modifying agent comprises a crosslinking agent that crosslinks the coating polymer. In embodiments, the pretreatment polymer has an affinity for the coating polymer.

Further disclosed herein, in embodiments, are methods for modifying the surface of fibers in a fibrous web, comprising the steps of: providing a plurality of fibers capable of being arranged in a fibrous web, coating the plurality of fibers with an emulsion comprising a continuous aqueous phase and a discontinuous phase comprising a surface-modifying agent, wherein the surface-modifying agent comprises a polymeric system capable of depositing a polymer on a fiber surface, arranging the plurality of fibers to form the fibrous web before, during, or after the step of coating the fibers, evaporating the continuous aqueous phase of the emulsion, coalescing the discontinuous phase to form an even coating disposed on the fiber surface of the plurality of fibers, and engaging the polymeric system to deposit the polymer on the fiber surface of the plurality of fibers, thereby modifying the fiber surface. In embodiments, the polymeric system comprises a polymer precursor and the step of engaging the polymeric system comprises activating the polymer precursor to form the polymer to be deposited on the fiber surface. In embodiments, the surface-modifying agent further comprises an additive that interacts with the polymer on the fiber surface. In embodiments, the method further comprises the step of crosslinking the polymer on the fiber surface. In embodiments, the method further comprises an initial step of pretreating some or all of the plurality of fibers, to be performed before the step of providing the plurality of fibers.

### DETAILED DESCRIPTION

Disclosed herein, in embodiments, are systems and methods for surface-modification of fibers based on the use of aqueous oil-in-water emulsions to deposit the surface-modifying agents on fibrous structures or fibrous webs. As used herein, the term “fibrous structure” or “fibrous web” refers to any arrangement of individual fibers or filaments that are interlaid with one another. In some embodiments, the fibrous structure or web has a nonwoven character. In some embodiments, the fibers or filaments form a disorganized pattern (e.g., a substantially random formation or structure whose organization has little discernable pattern). Some techniques for fabricating fibrous structures are known in the art, including papermaking techniques and other techniques for making nonwoven materials.

As used herein, the term “fiber” can refer to any filamentous entity, whether natural or synthetic, that possesses a large aspect ratio (e.g., a dimensional length much larger than its cross-sectional dimension (e.g., a diameter)). For instance, in embodiments, the aspect ratio of the fibers can be larger than about 10, 20, 30, 50, or 100. The term “fiber” comprises larger fibers and microfibers. A microfiber is identified by having a small cross-sectional width (i.e., diameter), of no more than 100 microns in some embodiments. In embodiments, a microfiber may have an average cross-sectional width between 0.5 and 50 microns. In other embodiments, a microfiber may have an average cross-sectional width between 4 and 40 microns. In embodiments, a microfiber may have an average cross-sectional width less than 30 microns. The size of the microfibers can also be characterized in terms of denier units. In some embodiments, the microfibers, on average, are less than about 10 denier, or less than about 5 denier, or less than about 2 denier, or less than about 1 denier. Fibers larger than microfibers can be called “larger fibers.” As used herein, the term “larger fiber” refers to any synthetic or natural fiber that is longer and/or broader (i.e., having a larger cross-sectional length) than a microfiber. In some embodiments, larger fibers have a cross-sectional length (e.g., diameter) of 3-50 microns, 7-70 microns, or 150-600 microns, when used with smaller microfibers. One example of larger fibers is the cellulosic fiber associated with typical wood pulp formulations. In some embodiments, the ratio of the average cross-section dimensions (e.g., diameters) of the larger fibers to the microfibers can be greater than about 5, 10, 20, 50, 100, 500, 1000, 5000, or 10000. Fibers can have a plurality of fibrils (i.e., fibrillated fibers), which can potentially be separated. A fibrillated fiber can be produced from a fiber during fiber processing, where a precursor fiber is abraded or otherwise mechanically distressed. For example, processes (e.g., papermaking) can increase the internal and external fibrillation of a cellulosic pulp. A fibrillated fiber can include portions having a cross-sectional width less than about 100 microns, though the unfibrillated fiber may have a cross-sectional width larger than about 100 microns. Fibrils can have a nanofiber structure, e.g., exhibiting an average cross-sectional width between about 1 nm and 1 micrometer, or between about 50 nm and about 500 nm. In some embodiments, the microfibers are embodied as nanofibers, which can originate from fibrils of a microfiber.

The term “fiber” can refer to a synthetic fiber or a natural fiber. As used herein, the term “synthetic fibers” include fibers or microfibers that are manufactured in whole or in part. Synthetic fibers include artificial fibers, where a natural precursor material is modified to form a fiber. For example, cellulose (derived from natural materials) can be formed into an artificial fiber such as Rayon or Lyocell. Cellulose can also be modified to produce cellulose acetate fibers. These artificial fibers are examples of synthetic fibers. Synthetic fibers can be formed from synthetic materials that are inorganic or organic. As used herein, the term “natural fiber” refers to a fiber or a microfiber derived from a natural source without artificial modification. Natural fibers include vegetable-derived fibers, animal-derived fibers and mineral-derived fibers. Vegetable-derived fibers can be predominately cellulosic, e.g., cotton, jute, flax, hemp, sisal, ramie, and the like. Vegetable-derived fibers can include fibers derived from seeds or seed cases, such as cotton or kapok. Vegetable-derived fibers can include fibers derived from leaves, such as sisal and agave. Vegetable-derived fibers can include fibers derived from the skin or bast surrounding the stem of a plant, such as flax, jute, kenaf, hemp, ramie, rattan, soybean fibers, vine fibers, jute, kenaf, industrial hemp, ramie, rattan, soybean fiber, and banana fibers. Vegetable-derived fibers can include fibers derived from the fruit of a plant, such as coconut fibers. Vegetable-derived fibers can include fibers derived from the stalk of a plant, such as wheat, rice, barley, bamboo, and grass. Vegetable-derived fibers can include wood fibers. Animal-derived fibers typically comprise proteins, e.g., wool, silk, mohair, and the like. Animal-derived fibers can be derived from animal hair, e.g., sheep's wool, goat hair, alpaca hair, horse hair, etc. Animal-derived fibers can be derived from animal body parts, e.g., catgut, sinew, etc. Animal-derived fibers can be collected from the dried saliva or other excretions of insects or their cocoons, e.g., silk obtained from silk worm cocoons. Animal-derived fibers can be derived from feathers of birds. Mineral-derived natural fibers are obtained from minerals. Mineral-derived fibers can be derived from asbestos. Mineral-derived fibers can be a glass or ceramic fiber, e.g., glass wool fibers, quartz fibers, aluminum oxide, silicon carbide, boron carbide, and the like.

In embodiments, the surface-modifying agents for fibers disclosed herein comprise polymers or polymeric precursors (e.g., monomers, comonomers, oligomers, etc.) and mixtures thereof The term “polymeric system” shall refer to the polymers, polymeric precursors or mixtures thereof that can be used to coat fibers in a fibrous web with a polymeric coating. In embodiments, the polymeric system can be carried in the internal phase of an emulsion. As used herein, the term “emulsion” refers to a heterogeneous system comprised of two immiscible liquids, where one of the liquids is intimately dispersed in the other liquid in the form of droplets. The emulsion matrix is termed the external or continuous phase of the emulsion, and the phase comprised of the dispersed small droplets is called the internal or discontinuous phase. An emulsion can be stabilized or destabilized by the presence of surface-active agents called emulsifiers or demulsifiers. As an example, an emulsifying agent can form interfacial films around the droplets in the dispersed phase to create a barrier that interferes with the coalescence of the emulsified droplets. If an emulsion is destabilized, the droplets tend to coalesce into larger sizes, causing the phases to separate by gravitational settling. Conversely, in a stable emulsion, the two components remain admixed. As described herein, an aqueous continuous phase of an emulsion supports a discontinuous phase bearing the surface-modifying agents, (e.g., the polymeric system (monomers, comonomers, oligomers, polymers, and the like, and initiators (free radical, ionic, etc.)) for coating the fibers. The discontinuous oil phase can contain a variety of other surface-modifying agents, such as plasticizers (e.g., polyols), fire-retardants (e.g., brominated or phosphate molecules), crosslinkers (bifunctional or multifunctional), and the like.

In embodiments, for example, a polymeric system can deposit a coating on fiber surfaces that conveys advantageous properties to a fibrous web formed therefrom. For example, a polymeric system comprising a reactive monomer/initiator or a monomer/crosslinker or oligomers/crosslinker or a polymer/crosslinker can be emulsified in water using an appropriate surfactant/emulsifier. The surface-modifying agents contained in the emulsion can include other materials besides the polymeric system, i.e., additives that cooperate with the polymeric system or otherwise interact with the fibers to impart desirable properties. For example, the emulsion can contain a polymeric system comprising monomers and comonomers as the predominant species, followed by curing agents or crosslinking agents mixed with various additives that can impart different finishes to the web such as hydrophobicity, fire retardancy etc. These ingredients can all be mixed with a small amount of surfactant and added to water under high agitation. The resulting stable emulsion, comprising the polymeric system and the other additives, is then applied to the fibrous web.

After the emulsion is applied to the web, it coats the fibers relatively homogenously. As the web is processed through the dryer, the combination of shear and heat cause the aqueous phase of the emulsion to evaporate, leaving behind residual droplets of the oil phase. These same forces over time urge the droplets to coalesce. As the droplets coalesce, the polymeric system becomes engaged. As it is engaged, the polymeric system provides for the intact coating polymers that coat the fibers of the fibrous web. Engaging the polmeric system may involve merely depositing intact coating polymers that are already contained in the emulsion droplets on the fiber surface. Engaging the polymeric system may involve initiating and propagating polymerization from polymeric precursors, so that coating polymers are formed on the fiber surface.

As the polymeric system within the oil phase is affected by the high temperature of the drying unit, the polymeric system cures, forming the coating polymer and incorporating the additives (such as lubricant, fire retardant, hydrophobicizer, and the like) that are present in the oil phase droplets. The result is a continuous application to the web fibers of a cured polymeric system comprising the coating polymer and the additives. The cure completes during the drying process and incorporates into the coating, all the additives that are present in the droplet.

In certain embodiments, the candidate fibers can be pretreated before the application of the surface-modifying agents, for example, so that the fibers carry a positive charge. Pretreatment can be carried out, for example, with a polycation. As used herein, the term “polycation” may include any polymer (e.g., copolymer) having a net positive charge, such as a polyamine. As used herein, the term “polyamine” may include any polymer or copolymer that has at least a portion of its repeat units containing an amine (quaternary, ternary, secondary, or primary). In embodiments, the polyamine may desirably contain some repeat units with primary amines due to the reactivity of a primary amine. The polymers (e.g., polycations) as used herein can have an average molecular weight which can range from 1,000 up to 10,000,000 but it is preferable to be between 10,000 to 500,000.

In embodiments, a polyamine useful as a pretreatment may be a polymer comprising chitosan or polyethyleneimine. In embodiments, a chitosan polymer may comprise a certain portion of higher molecular weight chitosan, i.e., chitosan with a viscosity of at least 800 cp when in a 1% acetic acid solution. In embodiments, the amount of higher molecular weight chitosan may be greater than 10%, greater than 20%, or greater than 30%. Those of skill in the art will appreciate that for certain polymers, e.g., chitosan, an exact molecular weight may not be available, because such structures are defined by viscosity rather than molecular weight.

As an example of pretreatment, a polycation, such as a polyamine, or some other binder or wet strength component, can be added directly to a mixture of the fibers dispersed in a slurry. The polycation can be attached to the fiber by covalent bonding, or through electrostatic, hydrogen bonding, or hydrophobic interactions, or it can spontaneously self-assemble onto the fiber surface, for example, or it can be precipitated onto the surface. Chitosan, for example, may be precipitated onto the fiber surfaces. Because chitosan is only soluble in an acidic solution, it may be precipitated onto the fibers or microfibers in a solution by adding base to a polyamine-fiber/microfiber dispersion until the chitosan precipitates onto the fibers that will form the fibrous web.

In embodiments, a pretreatment that provides functionalization of the fibers before exposure to a surface-modifying emulsion can be performed with cationic agents having specific properties. For example, the surface chemistry of the cellulosic and synthetic fibers can be changed by attaching selected polymers to the fiber surface to make them more hydrophilic or hydrophobic (e.g., chitosan analogs). For filtration membranes and other applications where low protein binding is necessary (such as biological applications and medical applications), synthetic and natural fibers can have further surface modifications, using, for example, polymers that contain PEG-like moieties (Jeffamines, Pluronics, Tectonics, chitosan analogs, and the like).

Following the functionalization of the fibers with the polycation, the fibrous web can be impregnated with an emulsion carrying the surface-modifying agents (i.e., the polymeric system and any desirable additives) stabilized with an anionic surfactant. Anionic surfactants familiar to those of skill in the art can be used, for example, surfactants such as sodium laureth sulfate, sodium dodecylbenzenesulfonate, sodium lauroyl sarcosinate, sodium lauryl sulfate, sodium myreth sulfate, sodium palmate, sodium pareth sulfate, sodium stearate, and the like. The electrostatic attraction between the emulsion droplets and the fibers allows the deposition of the emulsion on the fibers in a uniform manner, ensuring a uniform coating of the web. The emulsion droplets that flow along the fiber length result in the deposition of the polymeric system, which then forms a thin and uniform coating upon drying due to the combination of shearing and the drying process.

In embodiments, crosslinking agents contained in the emulsion droplets can be activated during the drying, or during a heat-curing phase. Crosslinking is advantageous because it helps retain the dimensional stability of sheets produced from the fibrous web, and also helps retain the pore dimensions of a consistent and unchanging size, along with providing additional durability to the fibrous web. For example, a polymeric system comprising acrylate monomers can include multifunctional comonomers such as CN975 hexafunctional urethane acrylate (Sartomer LLC, Exton Pa.), to provide high crosslinking density and thereby abrasion resistance to the coatings.

In embodiments, the polymeric system (e.g., a monomer/crosslinker system) in the emulsion drops can be engineered to provide different functionalities to the fibrous web, such functionalities being derived from the crosslinking behavior or the characteristics of the polymeric system itself. As an example, multifunctional monomers could be chosen for the polymeric system, such that the resulting coating is hard, solvent and scratch resistant, and adapted for high temperature environments. In applications requiring high temperature resistance, such aromatic reactive compounds can be incorporated into the fibrous web. Such resonance-stabilized aromatic structures (e.g., aromatic acrylates such as CN2601 (Sartomer LLC, Exton Pa.)) provide high temperature stability and solvent resistance. In another embodiment when pliability of the coating is required, a reactive polyol could be used to provide the flexibility to the coated fibrous web. In another embodiment, brominated aromatic acrylates (Sartomer LLC, Exton Pa.) can be used as comonomers with acrylate monomers in a polymer system suspended in the aqueous emulsion to impart both high temperature resistance and fire retardancy in one step. In embodiments, resonance-stabilized aromatic structures that impart advantageous properties (e.g., high temperature resistance and/or fire retardancy) can be incorporated into a crosslinked network. In other embodiments, such structures can be incorporated into the cured polymer itself, initiated to polymerize with a majority monomer by free radical initiation, for example.

In certain embodiments, the internal phase of the emulsion can contain other additives that produce additional desirable properties beyond those imparted by the polymeric system itself. For example, the emulsion droplets can contain fire retardants as additives that can be incorporated into the cured coating layer. As another example, the emulsion droplets can contain biocidal agents to kill targeted organisms, to remove them from the solutions being filtered, or to preserve the longevity of the filters in settings where microorganisms can grow on the fibers.

A polymeric system carried in an aqueous emulsion can comprise reactive silicones, especially if hydrophobicity is desired for the fibrous web. For example, the polymeric system can comprise peroxide-cured or platinum-cured silicone monomers or oligomers.

### EXAMPLES

### Materials

Hexamethylenetetramine, Aldrich, USA
D.E.N. 439 Epoxy Novolac Resin (Phenol, Formaldehyde Glycidyl Ether Polymer), Dow Chemicals, Midland, Mich., USA
Sodium Lauryl Sulfate, Spectrum Chemicals, NJ, USA
Poly(Propylene Glycol) Diglycidyl Ether (Mn=640), Aldrich, USA
Chitosan cg110, Primex, Siglufiodur, Iceland
Poly(diallyldimethylammonium chloride) 20 wt % in Water, MW 400,000-500,000, Aldrich
Arofene 8426-ME-63 Resin, Phenolic-formaldehyde resin in Methanol/Ethanol, Ashland Chemicals, Covington, Ky., USA

### Example 1

### Cationic Functionalization of Fibrous Web with PolyDADMAC

A fibrous web comprising cellulose fibers can be functionalized with a dilute solution of Polydiallyldimethylammonium chloride (polyDADMAC). The inherently ionic nature of the cellulose fibers can complex readily with the quaternary amine groups on the polyDADMAC, yielding a permanently cationic fibrous web.

### Example 2

### Preparation of Paper Comprising Cationically Modified Cellulose Fibers

A sheet of paper (650 grams per square meter) was dipped in a solution containing 0.1% Chitosan solution in acidic water (pH 4). Once the paper was completely saturated with the solution, 0.1M NaOH was dripped slowly while monitoring the pH to raise to pH 8. This enabled chitosan to precipitate out of the solution and bind to the cellulose papers. The paper was them removed from the solution, placed between absorbent couch sheets and pressed using a steel hand roll to remove excess water and then dried at 110° C. on a speed dryer.

### Example 3

### Preparation of Emulsions Containing Reactive Polymers (Polymer Systems)

A phenol-formaldehyde resin reactive solution in methanol/Ethanol (Arofene 8426-ME-63 Resin) was used as an impregnating solution. To this solution, was added sodium lauryl sulfate solution in water at 10% concentration under agitation until the solution turned cloudy. The resulting cloudy solution was further diluted to 10% consistency in water to prepare a water emulsion of the phenol formaldehyde solution. The emulsion droplets containing the reactive polymeric resin were now stabilized and provided with anionic charge in the water emulsion by the anionic surfactant.

### Example 4

### Preparation of Reactive Emulsion using Epoxy Modified Phenolic Resin

An Epoxy Novolac phenol formaldehyde resin (D.E.N. 439 Epoxy Novolac Resin) was dissolved in methanol at 10% by weight. To this solution was added crosslinker Hexamethylenetetramine, 3% by weight of the resin. To this mixture was added a 10% solution of Sodium Lauryl Sulfate under agitation till a cloudy stable suspension was observed. This emulsion was further diluted to 1% solution with water. The resulting emulsion was used as an impregnation solution. The emulsion droplets containing the reactive polymeric resin were now stabilized and provided with anionic charge in the water emulsion by the anionic surfactant.

### Example 5

### Preparation of Reactive Emulsion using Plasticizing Crosslinkers

An Epoxy Novolac phenol formaldehyde resin (D.E.N. 439 Epoxy Novolac Resin) was dissolved in methanol at 10% by weight. To this solution was added crosslinker Hexamethylenetetramine, 3% by weight of the resin. To this solution, Poly(Propylene Glycol) Diglycidyl Ether was added as a plasticizer by 10% by weight of the resin. The resulting clear solution was emulsified by adding 10% solution of Sodium Lauryl Sulfate under agitation till a cloudy but stable emulsion was obtained. The emulsion droplets containing the reactive polymeric resin were now stabilized and provided anionic charge in the water emulsion by the anionic surfactant.

### Example 6

### Impregnation of Paper using Reactive Solutions

Impregnating solutions and emulsions as prepared in Examples 3, 4 and 5 were used for preparing paper/phenolic composites. For each experiment, a strip of the cationically modified paper prepared in accordance with Example 2 was dipped into a beaker containing the anionically modified reactive emulsion, pressed using a steel hand roller to remove excess emulsion and cured at 160° C. for 120 s to obtain a completely cured composites. The reactive emulsions described in Examples 3 and 4 gave rigid and strong composites. The emulsion described in Example 5 resulted in a strong but pliant composite due to the plasticizing action of Poly(Propylene Glycol) Diglycidyl Ether which had been incorporated in the cross-linked matrix.

### Example 7

### Impregnating a Fibrous Web using Amine-Reactive Silicone Emulsions

An amine-functionalized fibrous web (prepared, for example, in accordance with Example 1 or 2) can be impregnated with emulsified epoxidized silicone polymers. As examples, both difunctional or the multifunctional Silmer EP C50, Silmer EPC C50, Silmer EP J10, Silmer EP Di-50, Silmer EP Di-100, Silmer EPC Di-50 epoxidized silicones (SilTech Corp, Ontario, Calif.) can be emulsified with an anionic surfactants such as lauryl sulfate to create impregnating solutions. A fibrous web can then be dipped into a bath containing these silicones. The silicone-containing web can be cured by drying to initiate and complete crosslinking reaction between amines and epoxy, resulting in an extremely conformal nanocoating that resists water absorption.

### Example 8

### Impregnation of a Fibrous Web using Reactive Acrylate Emulsions

A fibrous web can be impregnated with an emulsified acrylate-terminated silicone polymers mixed with a free radical initiator such as azoisobutyronitrile, or a peroxide such as benzoyl peroxide. The acrylate-functionalized silicones such as Silmer ACR D208, Silmer ACR D2, Silmer ACR Di-10, Silmer ACR Di-50, Silmer ACR Di-1508 (SilTech Corp., Ontario, Calif.) can be emulsified with an anionic surfactants such as lauryl sulfate and a free radical initiator such as the peroxide initiator Photostab 100 to create impregnating solutions.

The fibrous web can then be dipped into a bath containing the reactive silicones, followed by curing at the drying temperature of the web (>170° C.) to complete crosslinking reaction between the acrylate groups. Alternatively the web coating can be cured by exposing the coating to an UV radiation source.

### Example 9

### Impregnation of a Fibrous Web with Fire Retardants

Phosphorus-based fire retardants such as phosphate esters, phosphonium derivatives and phosphonates can be added to an aqueous-based emulsion containing a polymer system. These agents can be physically trapped in crosslinked structures formed by the polymeric system, thereby imparting fire retardancy. For example, phosphate esters such as triethyl or trioctyl phosphate, or triphenyl phosphate can be used. The dosage levels of fire retardants are usually in a few parts per hundred parts of the solids in the emulsion.

### Example 10

### High Crosslinking Density

SR 9008 (Sartomer USA, Exton Pa.), a trifunctional acrylate ester, can be used to provide high crosslink density and high dimensional stability to the coating. In a typical composition, 25% SR 9008 can be mixed with EB767 polyurethane acrylate coating resin (UCB Chemical Corp, Smyrna Ga.) and appropriate initiator system to create an acrylate emulsion capable of having high cross link density. The SR 9008 content can be varied to alter the crosslink density of the resulting coating.

### Example 11

### Addition of Plasticizer

SR 344 (Sartomer USA, Exton Pa.), a polyethyeleoxide acrylate reactive plasticizer, can be mixed with EB767 polyirethane acrylate coating resin (UCB Chemical Corp, Smyrna Ga.) and appropriate initiator system to create a very flexible coating for applications requiring pliability.

### EQUIVALENTS

As described herein, embodiments provide an overall understanding of the principles, structure, function, manufacture, and/or use of the systems and methods disclosed herein, and further disclosed in the examples provided below. Those skilled in the art will appreciate that the materials and methods specifically described herein are non-limiting embodiments. The features illustrated or described in connection with one embodiment may be combined with features of other embodiments. Such modifications and variations are intended to be included within the scope of the present invention. As well, one skilled in the art will appreciate further features and advantages of the invention based on the above-described embodiments. Accordingly, the invention is not to be limited by what has been particularly shown and described, but rather is to be delimited by the scope of the claims. All publications and references cited herein are expressly incorporated herein by reference in their entirety. The words “a” and “an” are replaceable by the phrase “one or more.”

While this invention has been particularly shown and described with references to preferred embodiments thereof, it will be understood by those skilled in the art that various changes in form and details may be made therein without departing from the scope of the invention encompassed by the appended claims.

What is claimed:

1. A formulation for coating a fibrous web, comprising:
an emulsion capable of deposition on the fibrous web, the emulsion comprising an aqueous continuous phase and a discontinuous internal phase comprising a surface-modifying agent.

2. The formulation of claim 1, wherein the fibrous web comprises a population of fibers that are pretreated with a pretreatment polymer.

3. The formulation of claim 2, wherein the pretreatment polymer is a polycation.

4. The formulation of claim 1, wherein the fibrous web comprises cellulose fibers.

5. The formulation of claim 1, wherein the fibrous web comprises two populations of dissimilar fibers.

6. The formulation of claim 1, wherein the surface-modifying agent comprises a polymeric system that forms a coating polymer on fibers of the fibrous web following evaporation of the aqueous continuous phase of the emulsion.

7. The formulation of claim 6, wherein the surface-modifying agent further comprises an additive.

8. The formulation of claim 7, wherein the additive imparts to the fibrous web a property selected from the group consisting of fire resistance, flame retardation, lubricity, hydrophobicity, and plasticity.

9. The formulation of claim 6, wherein the polymeric system further comprises a crosslinking agent that crosslinks the coating polymer.

10. The formulation of claim 6, wherein the polymeric system comprises a polymeric precursor.

11. The formulation of claim 2, wherein the pretreatment polymer has an affinity for the coating polymer.

12. A method for modifying the surface of fibers in a fibrous web, comprising:
providing a plurality of fibers capable of being arranged in a fibrous web,
coating the plurality of fibers with an emulsion comprising a continuous aqueous phase and a discontinuous phase comprising a surface-modifying agent, wherein the surface-modifying agent comprises a polymeric system capable of depositing a polymer on a fiber surface,
arranging the plurality of fibers to form the fibrous web before, during, or after the step of coating the fibers,
evaporating the continuous aqueous phase of the emulsion,
coalescing the discontinuous phase to form an even coating disposed on the fiber surface of the plurality of fibers, and
engaging the polymeric system to deposit the polymer on the fiber surface of the plurality of fibers, thereby modifying the fiber surface.

13. The method of claim 12, wherein the polymeric system comprises a polymer precursor and the step of engaging the polymeric system comprises activating the polymer precursor to form the polymer to be deposited on the fiber surface.

14. The method of claim 12, wherein the surface-modifying agent further comprises an additive that interacts with the polymer on the fiber surface.

15. The method of claim 12, further comprising the step of crosslinking the polymer on the fiber surface.

16. The method of claim 12, further comprising an initial step of pretreating some or all of the plurality of fibers, to be performed before the step of providing the plurality of fibers.
